(19) United States
(12) Patent Application Publication
(10) Pub. No.: US 2019/0124885 A1
(43) Pub. Date: May 2, 2019

(54) PET COMB AND METHOD OF USE

(71) Applicant: SCOTT FETZER COMPANY/CLEVELAND WOOD PRODUCTS DIVISION, Westlake, OH (US)

(72) Inventors: Ryan Pereira, Westlake, OH (US); Eric C. Stegens, Olmsted Falls, OH (US)

(21) Appl. No.: 16/155,260

(22) Filed: Oct. 9, 2018

Related U.S. Application Data
(60) Provisional application No. 62/569,893, filed on Oct. 9, 2017.

(51) Int. Cl. A01K 13/00; A46B 5/00; A46B 7/04; A46B 9/02; A46B 15/00; A47L 9/06

(52) U.S. Cl. CPC A01K 13/00; A46B 5/0095; A46B 7/044; A46B 2200/1093; A46B 15/0055; A47L 9/0613; A47L 9/0673; A46B 9/02

(57) ABSTRACT

A pet comb comprising a body partially housing a pet engagable portion and housing a lifter coupled to a biasing member. The lifter configured to move responsive to an application of force to said lifter. The body comprising a handle and a pet engagable portion support comprising a debris ejector, the debris ejector is directly adjacent the pet engagable portion. The pet engagable portion is removably coupled to the lifter. The pet engagable portion having a resting position wherein the biasing member maintains the pet engagable portion at least partially extending out of the body absent the application of force and a retracted position wherein the pet engagable portion is retracted into the body, responsive to the application of force moving the lifter. The pet engagable portion moves into the retracted position, said move removes debris from the pet engagable portion via the at least one debris ejector.

### CROSS REFERENCES TO RELATED APPLICATIONS

The present application claims priority under 35 U.S.C. § 119(e) to currently pending U.S. Provisional Patent Application Ser. No. 62/569,893 filed Oct. 9, 2017. The above-identified application is incorporated herein by reference in its entirety for all purposes.

### FIELD OF DISCLOSURE

The present disclosure relates to a pet comb and method of making and using the same, and more specifically, a vacuum adapted, fur auto-ejecting, changeable comb pet brush.

### BACKGROUND

Animals require care, and this care includes brushing out their coats and/or fur to remove pests, knots, to increase coat health, or simply because the animal enjoys being brushed. Combs for furred animals, dog, cats, bunnies, ferrets, etc. that typically retain hair which has to be manually removed from the brush and/or comb after a critical mass of hair has accumulated. The hair that is removed during brushing can easily end up on the floor, or create a mess. Further, multiple combs are needed for multiple animal types and/or comb functionalities. For example, a tooth length of a comb that is optimal for a long haired dog would be longer than a tooth length of a comb that is optimal for a short haired dog. Additionally, an optimal comb width for a large dog would be different than an optimal width for a smaller dog or cat, as large dogs have a greater surface area to cover than smaller dogs or cats. Also, combs have specific functionalities, such that a person would be required to buy one comb for shedding, another for flee removal, and yet another for tick removal. Traditional combs and/or brushes include teeth that are directly attached to a handle and moreover, that are not removable. These teeth can injure or discomfort animals if too much pressure is applied during brushing.

### SUMMARY

One aspect of the disclosure comprises a pet comb comprising a body partially housing a pet engagable portion and housing a lifter coupled to a biasing member, the lifter configured to move responsive to an application of force over a force threshold to the lifter. The body comprises a handle and a pet engagable portion support comprising at least one debris ejector, at least one debris ejector directly adjacent the pet engagable portion. The pet engagable portion removably coupled to the lifter, the pet engagable portion having a resting position wherein the biasing member maintains the pet engagable portion at least partially extending out of the body absent the application of force over the force threshold and a retracted position wherein the pet engagable portion is retracted into the body, responsive to the application of force over the force threshold moving the lifter, the pet engagable portion moves into the retracted position, the movement into the retracted position removes debris from the pet engagable portion via the at least one debris ejector.

Another aspect of the present disclosure comprises a pet grooming tool with auto debris eject feature and interchangeable pet engagable members comprising a body comprising a handle, a lifter that is housed within the body and is connected to a pet engagable portion, a biasing member mechanically connected to the lifter, wherein force applied to the lifter alters a position of the pet engagable portion, and a debris ejector portion that mechanically interacts with the pet engagable portion to eject debris when the lifter alters the position of the pet engagable portion.

Yet another aspect of the present disclosure comprises a pet grooming tool with optional independently rotatable vacuum coupling and auto debris eject feature and interchangeable pet engagable members. The pet grooming tool comprises a body comprising a handle and defining an air channel, a lifter that is housed within the body and is connected to a pet engagable portion, a biasing member mechanically connected to the lifter, wherein force applied to the lifter alters a position of the pet engagable portion, and a debris ejector portion that mechanically interacts with the pet engagable portion to eject debris when the lifter alters the position of the pet engagable portion, the debris ejector portion comprising one or more vents configured to intake debris that has been ejected when the lifter alters the position of the pet engagable portion.

Yet another aspect of the present disclosure comprises pet comb comprising a handle formed by a body defining a longitudinal axis, the handle for gripping the pet comb by the operator during use, a retraction button extending from a upper portion of the body, and a selectively moveable pet engagable portion extending from a lower portion of the body, extending parallel with the longitudinal axis, the retraction button being movably coupled to the pet engagable portion by a lever, the lever being disposed within the housing.

### BRIEF DESCRIPTION OF THE SEVERAL VIEWS OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals, unless otherwise described refer to like parts throughout the drawings and in which:

FIG. 1A is a front perspective view of a pet comb in accordance with one example embodiment of the present disclosure;

FIG. 1B is a front perspective view of a pet comb with a vacuum hose coupling in accordance with a second example embodiment of the present disclosure;

FIG. 2 is a left side perspective view of the pet comb of FIG. 1A;

FIG. 3 is a bottom perspective view of the pet comb of FIG. 1A;

FIG. 4 is a lower left side perspective view of the pet comb of FIG. 1A;

FIG. 5A is a cross sectional view of a body of a pet comb wherein internal components are in a perspective view seen approximately from the plane indicated by the line 5-5 of FIG. 1A;

FIG. 5B is a cross sectional view of a body of a pet comb with a vacuum coupling and second example embodiment of a lifter, wherein internal components are in a perspective view seen approximately from the plane indicated by the line 5-5 of FIG. 1A;

FIG. 5C is a cross sectional view of a body of a pet comb with a vacuum coupling and second example embodiment of a lifter, wherein internal components are in a perspective view seen approximately from the plane indicated by the line 5B-5B of FIG. 1B;

FIG. 5D is a second cross sectional view of a body of a pet comb with a vacuum coupling and second example embodiment of a lifter, wherein internal components are in a perspective view seen approximately from the plane indicated by the line 5-5 of FIG. 1A;

FIG. 6 is a cross sectional view of a body of a pet comb wherein internal components are in a perspective view seen approximately from the plane indicated by the line 5-5 of FIG. 1A;

FIG. 7A is a magnified perspective view of a portion FIG. 5A;

FIG. 7B is a magnified a cross sectional view of a pet comb with a second example embodiment of a lifter and a second example embodiment of a biasing member, wherein internal components are in a perspective view seen approximately from the plane indicated by the line 5B-5B of FIG. 1B;

FIG. 7C is a magnified cross sectional view of a body of a pet comb with a second example embodiment of a lifter and a second example embodiment of a biasing member, wherein said biasing member depressible in direction A, wherein internal components are in a perspective view seen approximately from the plane indicated by the line 5B-5B of FIG. 1B;

FIG. 8A is a perspective view of internal components of a pet comb in accordance with one example embodiment of the present disclosure;

FIG. 8B is a perspective view of internal components of a pet comb in accordance with a second example embodiment of the present disclosure;

FIG. 9A is a front plan view of a lifter and pet engagable support in accordance with an example embodiment of the present disclosure;

FIG. 9B is a front plan view of a lifter and pet engagable support in accordance with a second example embodiment of the present disclosure;

FIG. 10 is a front plan view of a pet engagable component in accordance with an example embodiment of the present disclosure; and

FIG. 11 is a schematic diagram illustrated a method of using the pet comb in accordance with an example embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements having similar characteristics and operational properties throughout unless otherwise noted. The present disclosure relates to a pet comb and method of making and using the same, and more specifically, a vacuum adapted, fur auto-ejecting, changeable comb-pet-brush.

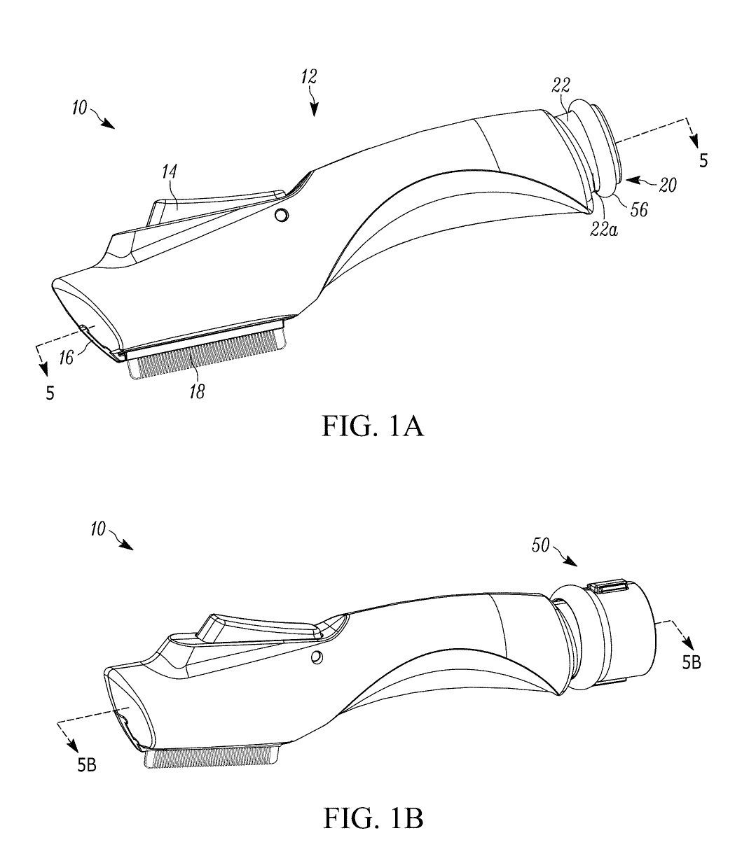

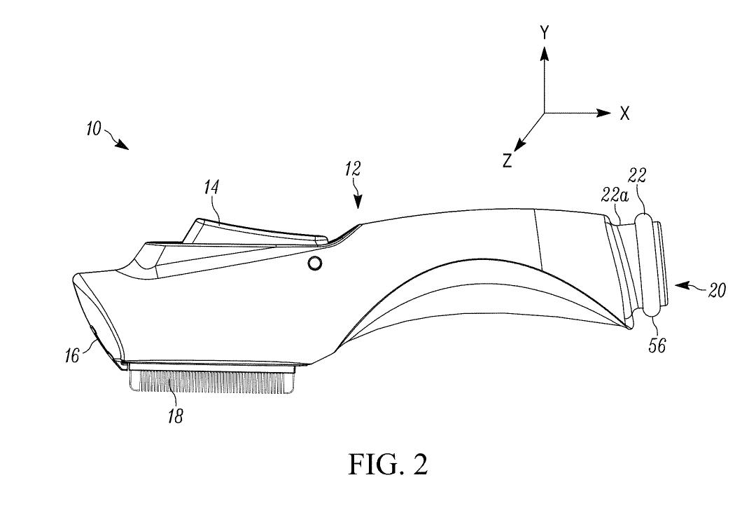

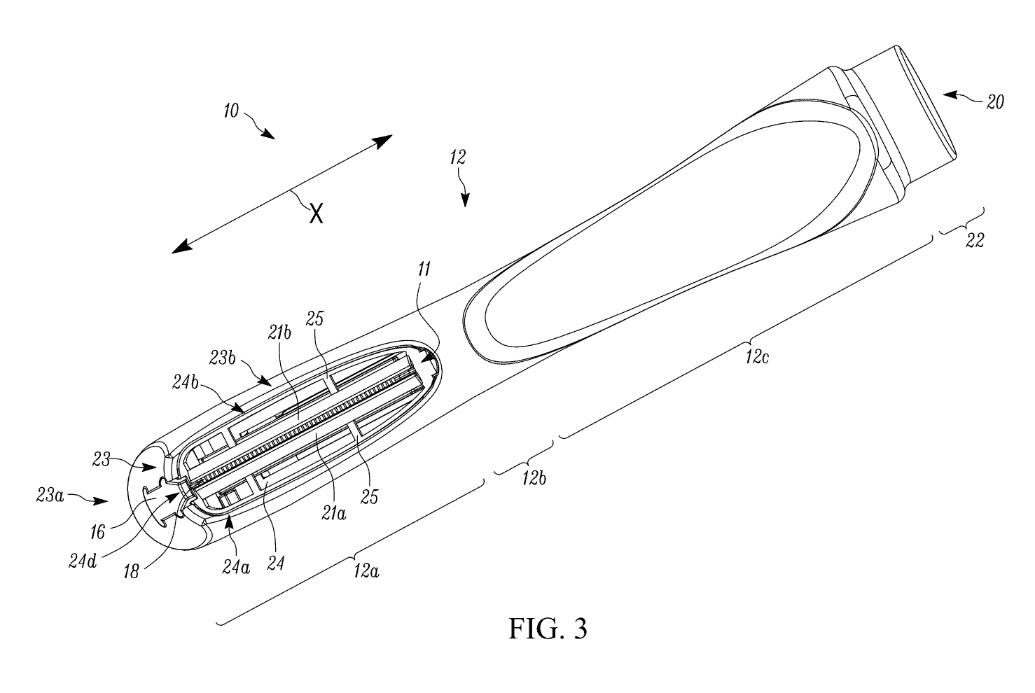

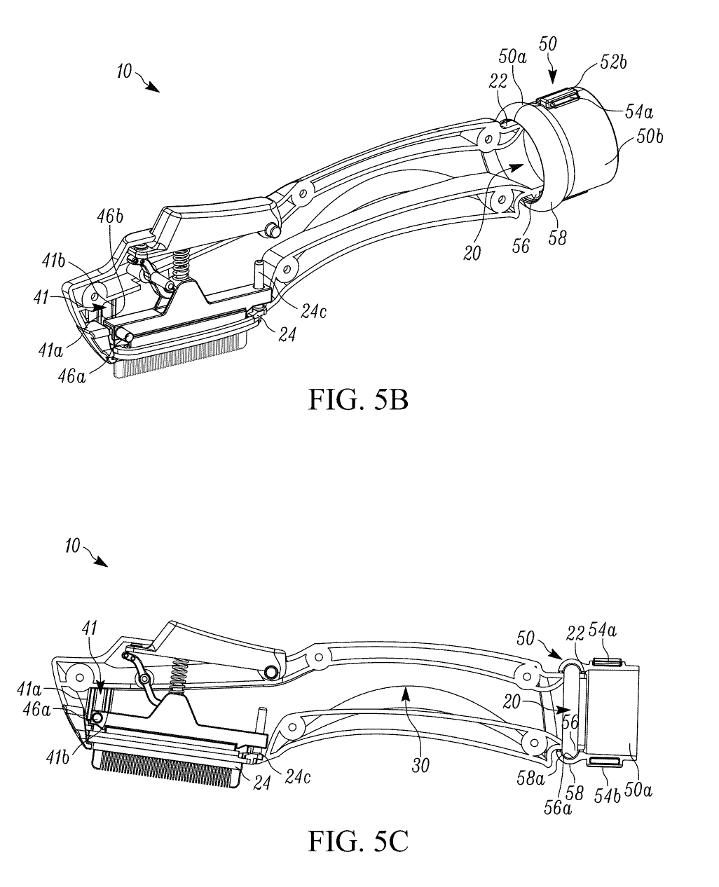

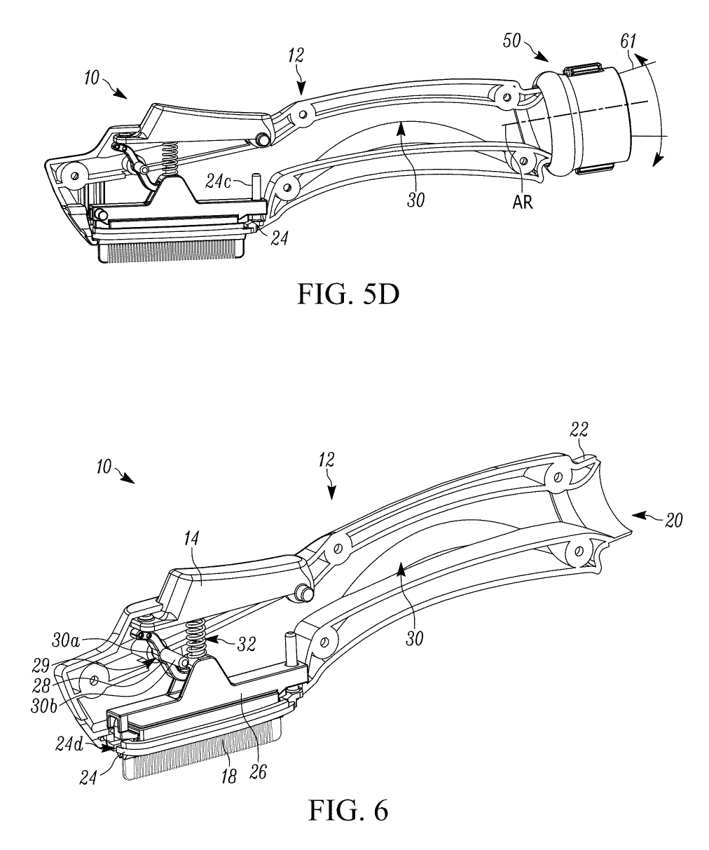

As illustrated in FIGS. 1A-10, a pet comb and/or brush 10 comprises a body 12 movably coupled to and supporting a pet engagable portion 18. The body 12 comprises metal, plastic, and/or polymeric materials. As illustrated in FIG. 3, the body 12 comprises at least one of a head 12a, a neck 12b, a handle 12c, and a vacuum attachment portion 22. In one example embodiment, the body 12 extends along an x-axis, wherein axes are relative terms used herein. The body 12 comprises a hollow structure defining a vacuum opening 20 at an open end of the body located on the vacuum attachment portion 22. As shown in the illustrated example embodiment of FIGS. 1A-1B, the vacuum attachment portion 22 comprises a neck portion 22a that is coupled to a coupling lip 56, wherein the coupling lip has a greater diameter or width than the neck portions 22a. The vacuum attachment portion 22 couples to an independently rotatable coupler 50. As shown in the illustrated example embodiment of FIGS. 5B-5D, the independently rotatable coupler 50 comprises first and second portions 50a, 50b that frictionally couple and/or clip together. The independently rotatable coupler 50 comprises a rigid material, such as plastic or metal.

The first and second portions 50a, 50b of the independently rotatable coupler 50 comprise complementary configurations, wherein the first and second portions comprise substantially identical indented portions 58. The indented portions 58 having an inner wall 58a that complementary to an outer surface 56a of the coupling lip 56, such that when the first and second portions 50a, 50b are coupled together, the coupling lip 56 is housed and retained within the indented portion 58.

In the illustrated example embodiment of FIG. 5C, the first portion 50a comprises a locking member 54a and a locking receptacle 54b. The second portion 50b comprises a second locking receptacle 52b, substantially the same as the locking receptacle 54b, and a second locking member (not shown) substantially the same as the locking member 54a. In one example embodiment, the independently rotatable coupler 50 is coupled to the body 12 by aligning the indented portion 58 of the first and second portions 50a, 50b with the coupling lip 56 and pressing the locking member 54a into the locking receptacle 52b, and the second locking member into the second locking receptacle 54b. The locking members 54a and the locking receptacles 52b, 54b will interlock to couple the body 12 to the independently rotatable coupler 50 via the indented portion 58 and the coupling lip 56. Diameters of the indented portion 58 of the independently rotatable coupler 50 are larger than the complementary diameters of coupling lip 58 of the body 12, allowing the body 12 to rotate independently of the independently rotatable coupler, but not so different to allow decoupling. Stated another way, the independently rotatable coupler 50 is concentrically aligned about an axis of rotation (AR) shared between the body 12 and a tubular member 61 providing a pressure differential (e.g., a vacuum tube). The independently rotatable coupler 50 allows for relative rotation of the tubular member 61 and the body about the axis of rotation AR.

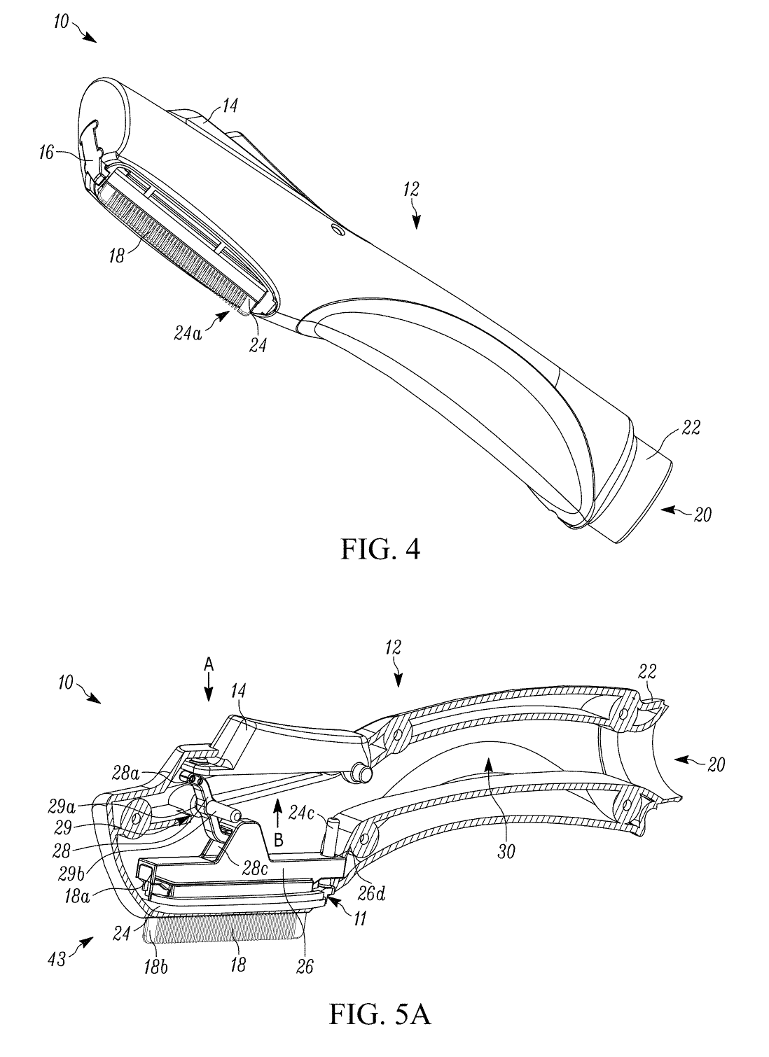

The body 12 also comprises a closed end located on the head 12a. The head 12a additionally defines a pet engagable opening 23 in the body 12 in which the pet engagable portion 18 is removably housed. In the illustrated embodiment of FIGS. 3-4, a front portion 23a of the pet engagable opening 23 is covered by a removable cap 16 and a bottom portion 23b of the pet engagable opening 23 is defined by a pet engagable support 24. The removable cap 16 comprises a flexible material, such as polyethylene, polypropylene, thermoplastic elastomer (TPE), or the like. The removable cap 16 covers the front portion 23a during use of the pet comb 10. The cap 16 is removed during removal or installation of the pet engagable portion 18 (e.g., one or more different pet engagable portions), wherein the pet engagable portion is inserted into an outward face 43 of a lifter 26 along an x-axis, the lifter comprised within and connected to the body 12 (see FIG. 5A).

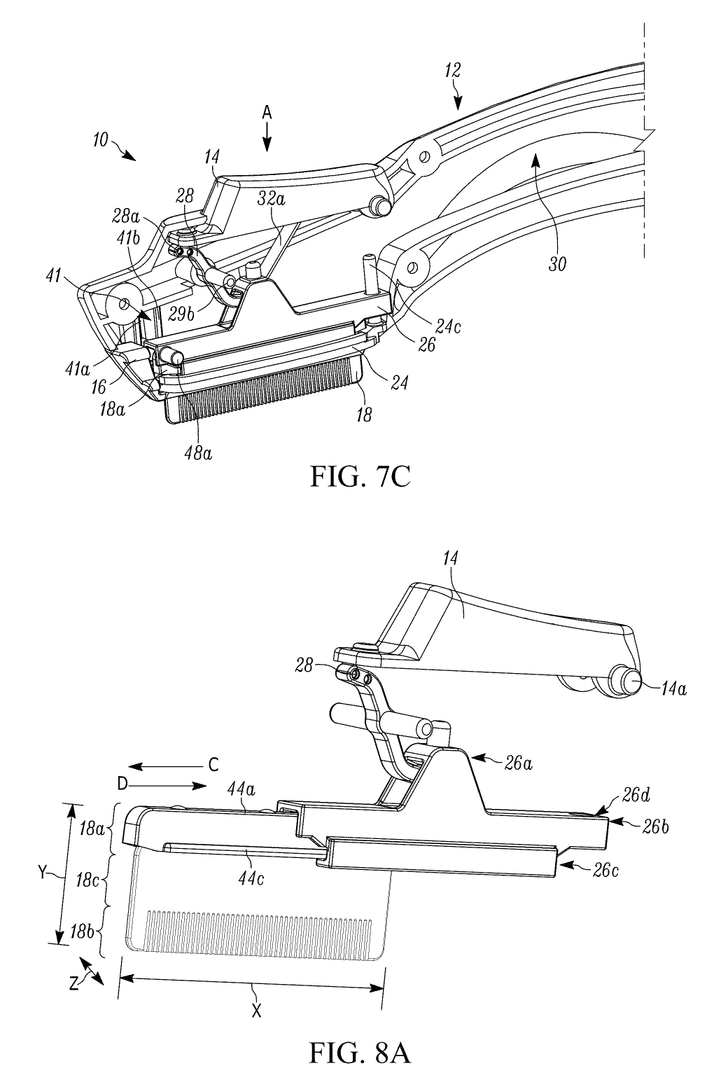

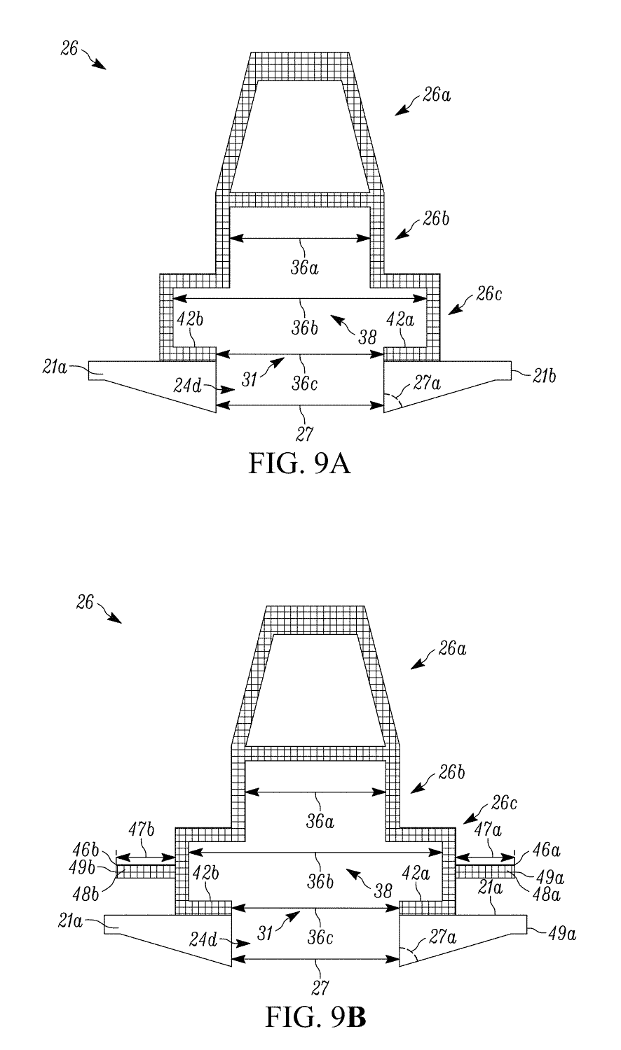

As illustrated in FIGS. 8A, 8B, and 10, the pet engagable portion 18 comprises a teeth portion 18b, a support portion 18c, and a connection portion 18a, wherein the teeth portion is connected to the connection portion 18a by the support portion, along a y-axis of the pet engagable portion. The teeth portion 18b, the support portion 18c, and the connection portion 18a extend co-axially along a common axis along the x-axis of the pet engagable portion (see FIG. 8A). The teeth portion 18b, the support portion 18c, and the connection portion 18a comprise same or different materials. In one example embodiment, the teeth portion 18b and the support portion 18c comprise metal and/or plastic, and the connection portion 18a comprises a metal, metalloid, and/or plastic. The teeth portion 18b is configured to directly engage with a pet, and be moved through a pet's fur such that a front face extending along the x-axis interacts with the fur as a user moves the pet comb 10 with or against the pet's fur. The front face of the pet engagable portion 18 extends along a same axis as the body 12.

The teeth portion 18b comprises a section that engages with the pet, and includes a variety of configurations. As in the illustrated example embodiment of FIGS. 8A-8B, the teeth portion 18b includes, for example, short teeth (under or equal to ⅜″ inches), long teeth (over ⅜″ inches) as measured along the y-axis, tightly packed teeth (2 or more teeth per ⅛″ inches), loosely packed teeth (less than 2 teeth per ⅜″ inches) as measured along the x-axis of the pet engagable portion, and/or any variation thereof. In one example embodiment, the teeth portion 18b is one of thinner or thicker along the z-axis relative to the support portion 18c. In another example embodiment, the teeth portion 18b is one of longer or shorter along the x-axis than the support portion 18c.

As illustrated in the example embodiment of FIGS. 8A, 8B, and 10, the connection portion 18a comprises a head member 44a and first and second wing portions 44b, 44c, respectively. The wing portions 44b, 44c extend transversely or perpendicularly away from the head member 44a. In the illustrated example embodiment of FIG. 10, the wing portions 44b, 44c, extend along the z-axis. The first and second wing portion 44b, 44c, extend first and second wing lengths 34b, 34c from sidewalls 45a, 45b of the head member 44a, such that a total wing length 34d is a sum of the first and second wing lengths 34b, 34c and a head length 34a. Although, the head member 44a and the first and second wing portions 44b, 44c are illustrated as rectangular, other geometric shapes are contemplated.

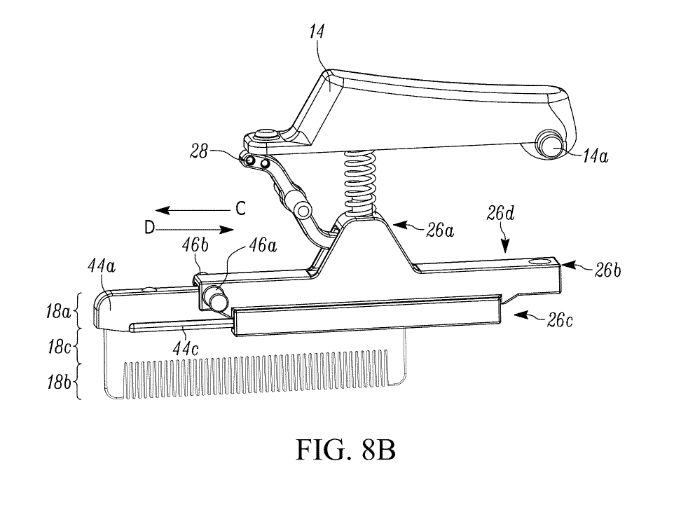

The connection portion 18a of the pet engagable portion 18 is inserted into the lifter 26 to couple the pet engagable portion to the body 12. As illustrated in FIGS. 5A-5D, 6, and 7A-7C, when the lifter 26 is coupled to the pet engagable portion 18, the lifter will, responsive to activation of a force transmitting member 14 (e.g., such as in direction A) be engaged by a lever 28 that will move the lifter along direction B (opposite of direction A), to lift the pet engagable portion into the body 12. The lifter 26 extends along the x-axis. As shown in the illustrated example embodiment of FIGS. 9A-9B, the lifter 26 comprises a lever section 26a, which couples to the lever 28 to move the lifter, a head support 26b and wing supports 26c that define a connection portion housing area 38, and a guide receiver 26d (see FIGS. 8A-8B, 9A-9B). In one example embodiment, such as illustrated in FIG. 8B, the lifter 26 comprises first and second guide arms 46a, 46b, that extend transversely or perpendicularly away from the head support 26b. The first and second guide arms 46a, 46b are configured to interact with a guide path 41 defined by raised sidewalls 41a, 41b in an interior section of the body 12 (see FIG. 5B, 5C, 7C). In the illustrated example embodiment of FIG. 9B, the first and second guide arms 46a, 46b, comprises a first length and second lengths 47a, 47b, respectively. The first length and second lengths 47a, 47b are configured such that sidewalls 48a, 48b of the first and second guide arms 46a, 46b are housed between the raised sidewalls 41a, 41b, and ends 49a, 49b of the first and second guide walls to avoid frictional or obstructional interactions with interior walls of the body 12.

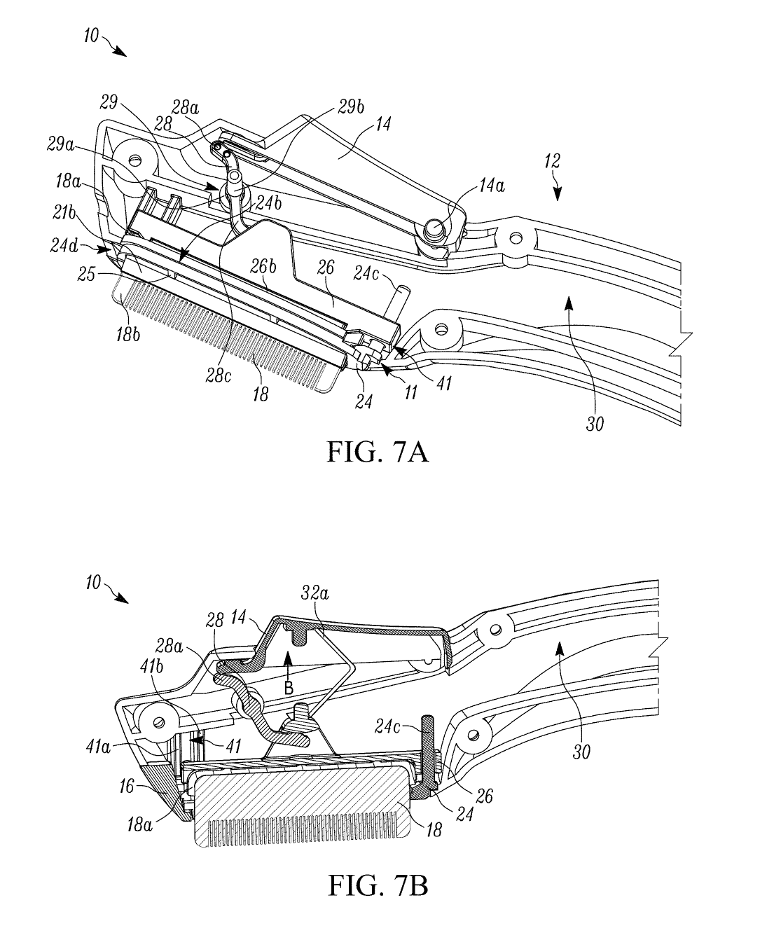

The activation of the force transmitting member 14 comprises applying a force greater than a force threshold (e.g., a force applied to the lever section 26a by a biasing member 32). The biasing member 32 applies force to the lifter 26 and comprises a spring, a hydraulic member, a magnet, or the like. In the example embodiment illustrated in FIGS. 7B-7C, the biasing member 32 comprises a lever arm 32a. In one example embodiment, the lever arm 32a comprises a springy or resilient material, such as metal or spring steel. The biasing member 32 extends the pet engagable portion 18 into a resting position, in which the pet engagable portion is at least partially extending outside the body. In one example embodiment, the biasing member 32 is in contact with force transmitting member 14, such that the biasing member is applying force by being braced against the force transmitting member. The biasing member 32 being housed in or in contact with the force transmitting member 14.

As illustrated in FIGS. 5A-5D, the force-transmitting member 14 interacts with the lever 28 at a force transfer location 28a. The lever 28 comprises first and second pivot arms 29a, 29b that are rotationally coupled to the body 12, such that when a force over the force threshold is applied to the force transfer location 28a, the lever rotates around the pivot aims 29 to raise the lifter 26 via a lifter connection location 28c that is coupled to the lever section 26a. In the illustrated example embodiment of FIG. 7C, the first and second guide arms 46a, 46b interact with the guide path 41 to keep the lifter 14 traveling along the y direction. In one example embodiment, the guide path 41 is mirrored on an opposing side of the body 12, such that each of the first and second guide arms interact with first and second guide paths (e.g., that are the same or substantially the same as the guide path 41).

In the illustrated example embodiments of FIGS. 5A-8B, a force transfer section of the lever 28 located between the force transfer location 28a and the pivot arms 29 is shorter than a lifter connection section of the lever located between the pivot arms and the lifter connection location 28c. In another example embodiment, the force transfer section is equal to or longer than the lifter connection section.

The biasing member 32 maintains a position of the pet engagable portion 18 absent an application of force over the force threshold to the force transmitting member 14, or direct application of direct force to the pet engagable portion 18. In one example embodiment, because the lever 28 uses rotational force providing a mechanical advantage, the force threshold to activate of the force transmitting member 14 is lower than a direct force required to overcome the biasing member through direct application of force to the pet engaging portion 18. The presence of the biasing member 32 reduces the instances where a pet engagable portion 18 is applied too forcefully to a pet, as the biasing member provides some give in such instances.

The lifter 26 supports the pet engagable portion 18 during use, during movement of the pet engagable portion into and out of the body 12, and provides a mechanism for easily inserting and removing different pet engagable portions. As illustrated in FIGS. 9A-9B, the wing supports 26c are substantially mirror images of each other, and a separated by a lifter slot 31. The lifter slot 31 extends along the x-axis between the wing supports 26c and ends at a stop on an internally facing end 41 of the lifter 26 (see FIG. 7A). The wing supports 26c extend at an angle transverse to or perpendicular to the head support 26b. Stated another way, the head support 26b extends along the y-axis and the wing supports 26c extend away from the head support along the z-axis. A distance 36c between the wing supports 26c defining the lifter slot 31 is equal to or greater than a support width 34e of the support portion 18c of the pet engagable portion 18 to allow the support portion to slide within the lifter slot (see FIGS. 8A, 8B, 10). Although the head support 26b and the wing supports 26c are illustrated as rectangular, other encapsulating geometric shapes are contemplated.

As illustrated in the example embodiment of FIGS. 7A and 8A, the head support 26b has a greater length along the x-axis than the wing supports 26c. The head support 26b comprises a guide receiver 26c at the internally facing end 41 of the lifter 26. The guide receiver 26d is configured to interact with a guide 24c that limits directions in which the lifter 26 can move (e.g., along a single plane), the guide will be explained in detail below. In the illustrated example embodiment of FIG. 7C, the first and second guide arms 46a, 46b interact with the guide path 41 to further limit directions in which the lifter 26 can move (e.g., works in conjunction with the guide 24c to limit the movement of the lifter 26 to a single plane).

The wings supports 26c are configured to be substantially the same size or slightly larger than the first and second wings 44b, 44c, and the head support 26b is configured to be substantially the same size or slightly larger than the head member 44a of the pet engagable portion, such that the connecting portion 18a of the pet engagable portion 18 fits within the lifter 26. For example, a wing distance 36b between the wing supports 26c is between 1 mm to 5 mm greater than the total wing length 34d, and a head support width 36a, measured along the z-axis, is between 1 mm-5 mm greater than the head length 34a. As illustrated in FIGS. 8A-10, the above dimensions allow for an easy sliding insertion, along direction D, or removal, along direction C of the pet engagable portion 18 into or out of the lifter 26.

Additionally, as illustrated in the example embodiments of FIGS. 3, and 7A-7C, the pet engagable portion 18 interacts with the pet engagement support 24. The pet engagable support 24 is coupled to and/or contiguous with the body 12. The pet engagable support 24 comprises a same or different material than the body 12. The pet engagable support 24 comprises a rigid plastic, such as polyvinyl chloride (PVC), high-density polyethylene (HDPE), or the like. As in the illustrated example embodiment of FIGS. 3 and 7A the pet engagable support 24 comprises first and second debris ejector 21a, 21b, one or more vents 24a, 24b, an entry slot 24d, and the guide 24c.

As shown in the illustrated example embodiment of FIG. 3, the first and second debris ejector 21a, 21b extend adjacent to the pet engagable portion 18 along the x-axis. In one example embodiment, a distance between the first and second debris ejector 21a, 21b is equal to the slot width 27 of the slot 24d (see FIG. 9A-9B). In another example embodiment, the distance between the first and second debris ejector 21a, 21b is equal to or greater than the support width 34e of the support portion 18c (see FIG. 10). The first and second debris ejectors 21a, 21b extend along parallel axes.

In the illustrated example embodiment of FIGS. 4, and 9A-9B, the first and second debris ejector 21a, 21b project at a first angle 27a away from the body 12, such that a portion extending along the x-axis nearest the pet engagable portion 18 has a greater width than a portion farthest from the pet engagable portion. The first angle 27a is between about 15° to 90°. The first angle 27a improves debris containment by directing the debris away from the pet engagable portion 18 for easy collection, or for debris evacuation through the one or more vents 24a, 24b, which are located to receive the debris.

The one or more vents 24a, 24b are adjacent to the first and second debris ejector 21a, 21b, respectively. In an example embodiment, a first vent 24a is adjacent the first debris ejector 21a, and the second debris ejector 21b is not present, likewise, in another example embodiment, a second vent 24b is adjacent the second debris ejector 21b, and the first debris ejector 21a is not present. The one or more vents 24a, 24b define openings through which debris that accumulates on the pet engagable portion 18 is evacuated responsive to the pet comb 10 being connected to a vacuum (e.g., through the vacuum attachment portion 22). In the illustrated example embodiment of FIG. 3, the one or more vents 24a, 24b extend along the x-axis along a same central axis as the body 12. In an example embodiment, the one or more vents 24a, 24b, include one or more crossbars 25 (see, for example, FIG. 7A) that are transverse or perpendicular to the first and second debris ejectors 21a, 21b.

As shown in the illustrated example embodiment of FIG. 3, the pet engagable support 24 defines the entry slot 24d, which extends along the x-axis between the first and second debris ejectors 21a, 21b. The entry slot 24d terminates at a guide end 11 of the pet engagable support 24. In one example embodiment, the one or more vents 24a, 24b, and the first and second debris ejectors 21a, 21b, converge at the guide end 11 to form a single structure. In another example embodiment, the slot width 27 (see FIG. 9A-9B) remains constant until the entry slot 24d terminates at the guide end 11.

As shown in the illustrated example embodiment of FIGS. 5A-5D, the guide 24c comprises a guiding member that extends transverse and/or perpendicular to the x-axis toward the inside 30 of the body 12. The guide 24c comprises a square, circular, conical or the like protrusion. A length that the guide 24c extends into the inside 30 of the body 12 is correlated to a motion range of the lifter 26, wherein the motion range corresponds to a length of the pet engagable portion 18 along the y-axis. The motion range is greater or equal to said length, such that all or most of the pet engagable portion 18 is retracted into the body when the lifter 26 is fully lifted (e.g., into a retracted position). Likewise, a path length of the guide path 41 extends vertically inside 30 of the body 12. The path length is correlated to the motion range of the lifter 26, wherein the motion range corresponds to the length of the pet engagable portion 18 along the y-axis. In another example embodiment, the length of the guide 24c is substantially equal to the path length of the guide path 41.

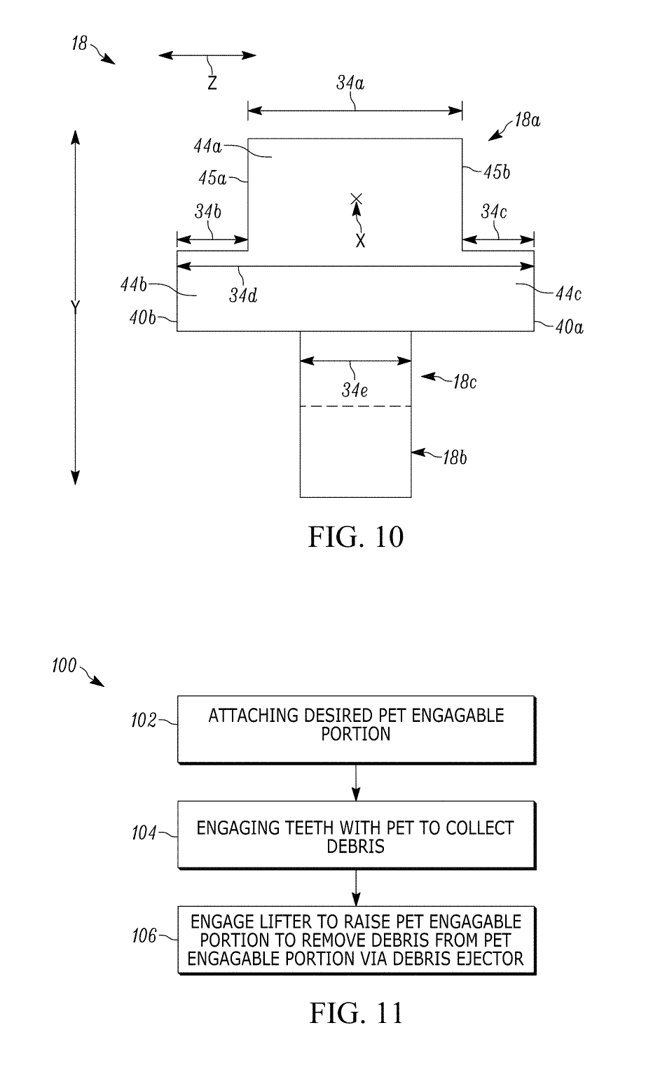

A method 100 illustrated in FIG. 11, of using the pet comb 10 is described herein. At 102, a desired pet engagable portion 18 is attached to the lifter 26 inside the body 12. At 104, the pet engagable portion 18 is put in contact with a pet to collect debris (e.g., hair, dirt, pets, knots, etc.). At 106, the lifter 26 is engaged to raise the pet engagable portion 18 to remove debris collected by pet engagable portion 18 via the first and/or second debris ejectors.

As illustrated in FIGS. 5A-7C, the force transmitting member 14 that alters a position of the pet engagable portion 18 to remove hair and/or debris utilizing the stationary first and second debris ejectors 21a, 21b. The position (e.g., directly adjacent and almost abutting the pet engaging member 18) and shape (e.g., comprising angle 27a to direct hair away) of the first and second debris ejectors 21a, 21b allow for efficient and easy removal of debris from the teeth portion 18b. Additionally, such as when the vacuum is attached to the vacuum attachment portion 22 via the coupling 50, the motion of the pet engagable portion into the body 12, directs the debris toward the vents 24a, 24b via the first and second debris ejectors 21a, 21b, for easy containment and evacuation of the debris. The vacuum, when attached, creates suction directed out of the body 12 via the vacuum opening 20. Thus, debris is easily contained with or without the vacuum because of the first and second debris ejectors 21a, 21b and the movement of the pet engagable portion 18 into and out of the body 12. Further, because the pet engagable portion 18 is movable and kept in place by the biasing member 32, pet discomfort and injuries are mitigated by preventing brushing too hard. Lastly, multiple pet engagable portions are utilizable via the single body 12, so that users need only purchase a single device, rather than multiple devices.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A pet comb comprising:
a body partially housing a pet engagable portion and housing a lifter coupled to a biasing member, the lifter configured to move responsive to an application of force over a force threshold to said lifter, the body comprising:
a handle; and
a pet engagable portion support comprising at least one debris ejector, the at least one debris ejector directly adjacent the pet engagable portion;
the pet engagable portion removably coupled to the lifter, the pet engagable portion having a resting position wherein the biasing member maintains the pet engagable portion at least partially extending out of the body absent the application of force over the force threshold and a retracted position wherein the pet engagable portion is retracted into the body, responsive to the application of force over the force threshold moving the lifter, the pet engagable portion moves into the retracted position, said movement into the retracted position removes debris from the pet engagable portion via the at least one debris ejector.

2. The pet comb of claim 1, wherein the pet engagable portion comprises a connection portion and an engagement portion, the connection portion removably coupled to the lifter

3. The pet comb of claim 1, wherein the body comprises a vacuum attachment and the pet engagable portion support comprises one or more vents to facilitate vacuuming debris through the body.

4. The pet comb of claim 1, further comprising a detachable independently rotatable coupler concentrically aligned about an axis of rotation shared between the body and a tubular member providing a pressure differential, the independently rotatable coupler allowing for relative rotation of the tubular member and said body about said axis of rotation.

5. The pet comb of claim 1, wherein a force transmitting member extends outside the body, the force transmitting member functionally coupled to the lifter, wherein force applied to the force transmitting member is transferred to the lifter.

6. The pet comb of claim 1, wherein the biasing member comprises at least one of a metal spring, a hydraulic spring, a lever arm, and a magnetic biasing member.

7. The pet comb of claim 1, wherein the body comprises a front opening for insertion and removal of the pet engagable portion, the front opening covered by a removable cap.

8. A pet grooming tool with an auto debris eject feature and interchangeable pet engagable members, the pet grooming tool comprising:
a body comprising a handle;
a lifter that is housed within the body and is connected to a pet engagable portion;
a biasing member mechanically connected to the lifter, wherein force applied to the lifter alters a position of the pet engagable portion; and
a debris ejector portion that mechanically interacts with the pet engagable portion to eject debris when the lifter alters the position of the pet engagable portion.

9. The pet grooming tool of claim 8, wherein the body comprises a removable cap that exposes the lifter for removal and attachment of one or more pet engagable portions.

10. The pet grooming tool of claim 8, wherein force is applied to the lifter is applied through a force transmitting member that is coupled to the lifter and the biasing member.

11. The pet grooming tool of claim 8, wherein the biasing member mechanically biases the pet engagable portion to at least partially extend out of the body absent the force applied to the lifter to alter the position of the pet engagable portion.

12. The pet grooming tool of claim 11, wherein responsive to the application of the force to the lifter to alter the position of the pet engagable portion, the pet engagable portion moves into the body, wherein the debris ejector portion mechanically interacts with the pet engagable portion to remove debris attached thereto.

13. The pet grooming tool of claim 8, wherein the pet engagable portion comprises a connection portion and an engagement portion, the connection portion removably coupled to the lifter.

14. The pet grooming tool of claim 13, wherein the body comprises an opening for insertion and removal of the pet engagable portion, the opening covered by a removable cap.

15. A pet grooming tool with optional independently rotatable vacuum coupling and auto debris eject feature and interchangeable pet engagable members, the pet grooming tool comprising:
a body comprising a handle and defining an air channel;
a lifter that is housed within the body and is connected to a pet engagable portion;
a biasing member mechanically connected to the lifter, wherein force applied to the lifter alters a position of the pet engagable portion; and
a debris ejector portion that mechanically interacts with the pet engagable portion to eject debris when the lifter alters the position of the pet engagable portion, the debris ejector portion comprising one or more vents configured to intake debris that has been ejected when the lifter alters the position of the pet engagable portion.

16. The pet grooming tool of claim 15, wherein the body comprises a removable cap that exposes the lifter for removal and attachment of one or more pet engagable portions having different teeth configurations.

17. The pet grooming tool of claim 15, wherein a force transmitting member extends outside the body, the force transmitting member functionally coupled to the lifter, wherein force applied to the force transmitting member is transferred to the lifter.

18. The pet grooming tool of claim 15, further comprising a detachable independently rotatable coupler concentrically aligned about an axis of rotation shared between the body a tubular member providing a pressure differential, the independently rotatable coupler allowing for relative rotation of the tubular member and said body about said axis.

19. A pet comb comprising:
a handle formed by a body defining a longitudinal axis, the handle for gripping the pet comb by the operator during use;
a retraction button extending from an upper portion of said body; and
a selectively moveable pet engagable portion extending from a lower portion of said body, extending parallel with said longitudinal axis;
the retraction button being movably coupled to said pet engagable portion by a lever, the lever being disposed within said housing.

20. The pet comb of claim 19 further comprising a debris ejector, the debris ejector having an opening for the passage of said pet engageable portion such that actuation of said retraction button results in rotation of said lever to translate said pet engageable portion through said opening to clear debris therefrom.
